(19) United States
(12) Patent Application Publication
(10) Pub. No.: US 2014/0140543 A1
(43) Pub. Date: May 22, 2014

(54) Micro-electroacoustic Device

(71) Applicant: Shao Yi, Shenzhen (CN)

(72) Inventor: Shao Yi, Shenzhen (CN)

(73) Assignees: AAC MICROTECH (CHANGZHOU) CO., LTD., Changzhou (CN); AAC ACOUSTIC TECHNOLOGIES (SHENZHEN) CO., LTD., Shenzhen (CN)

(21) Appl. No.: 14/083,392

(22) Filed: Nov. 18, 2013

(30) Foreign Application Priority Data
Nov. 16, 2012 (CN) 201220609349.1

(51) Int. Cl. H04R 1/00

(52) U.S. Cl. CPC H04R 1/00
USPC 381/162

(57) ABSTRACT

A micro-electroacoustic device includes a holder forming a hollow space, a magnetic system received in the hollow space, a vibrating system having a diaphragm and a coil driving the diaphragm for vibrating along a vibrating direction. The diaphragm is assembled with the holder and has an upper edge portion and a lower edge portion connected with the upper edge portion and assembled with the holder. The upper edge portion has a protruding part protruding away from the magnetic system and the lower edge portion has a recessed part recessed towards the magnetic system for supporting the voice coil evenly.

### FIELD OF THE INVENTION

The present disclosure relates to the art of micro-electroacoustic devices and, particularly to a micro-electroacoustic device having a diaphragm.

### DESCRIPTION OF RELATED ART

Generally, an electronic device, such as a mobile phone, uses a micro-electroacoustic device as a sound generator. A typical micro-electroacoustic device includes a holder having a hollow space, a magnetic system received in the hollow space, a diaphragm attached on the holder, and a coil connected with the diaphragm for driving the diaphragm in a vibrating direction. The diaphragm has a central portion, a protruding portion extending from the central portion and protruding forward along the vibrating direction, and a fixing portion extending from the protruding portion and fixed on the holder.

The protruding portion is capable of providing a restoring force when the diaphragm is activated by the coil to vibrate along the vibrating direction repeatedly. Because of the protruding portion protruding forward along the vibrating direction, the restoring force generated by the diaphragm during the vibration approaching the magnetic system is unequal to that generated by the diaphragm during the vibration away from the magnetic system, thereby increasing the sound distortion.

Therefore, it is desirable to provide a micro-electroacoustic device which can overcome the above-mentioned problem.

### BRIEF DESCRIPTION OF THE DRAWINGS

FIG. 1 is an illustrative assembled view of the micro-electroacoustic device in accordance with an exemplary embodiment of the present invention;

FIG. 2 is a cross-sectional view of the micro-electroacoustic device taken along line A-A in FIG. 1.

FIG. 3 is an enlarged view of part B in FIG. 2;

FIG. 4 is an illustrative exploded view of the micro-electroacoustic device in FIG. 1.

### DETAILED DESCRIPTION OF THE EXEMPLARY EMBODIMENT

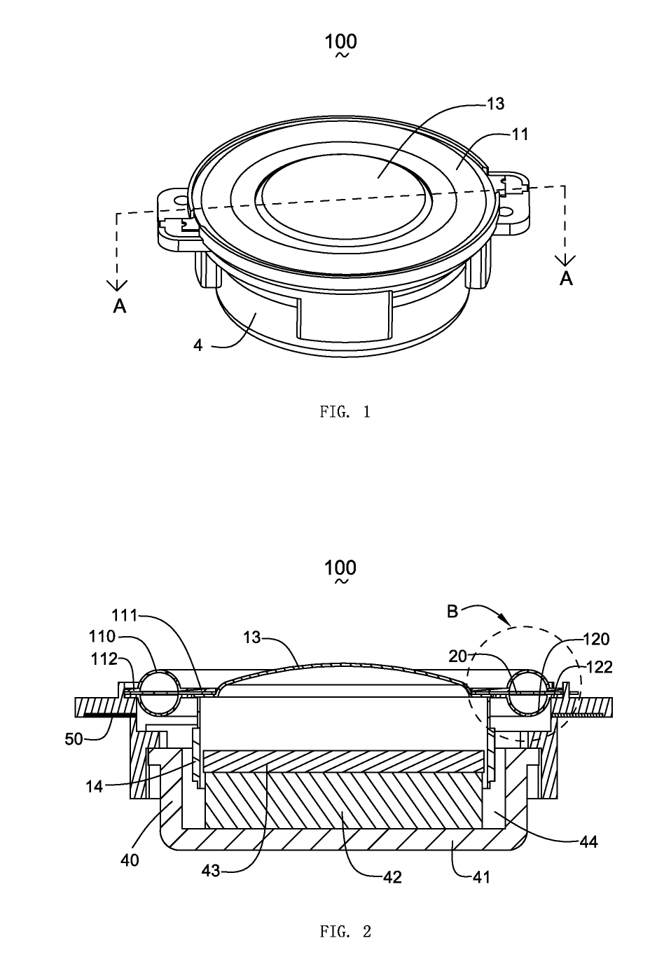

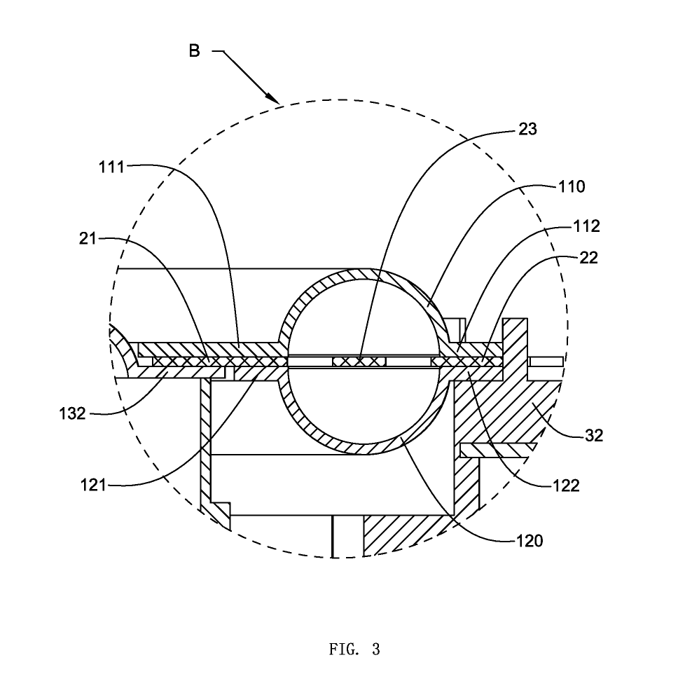

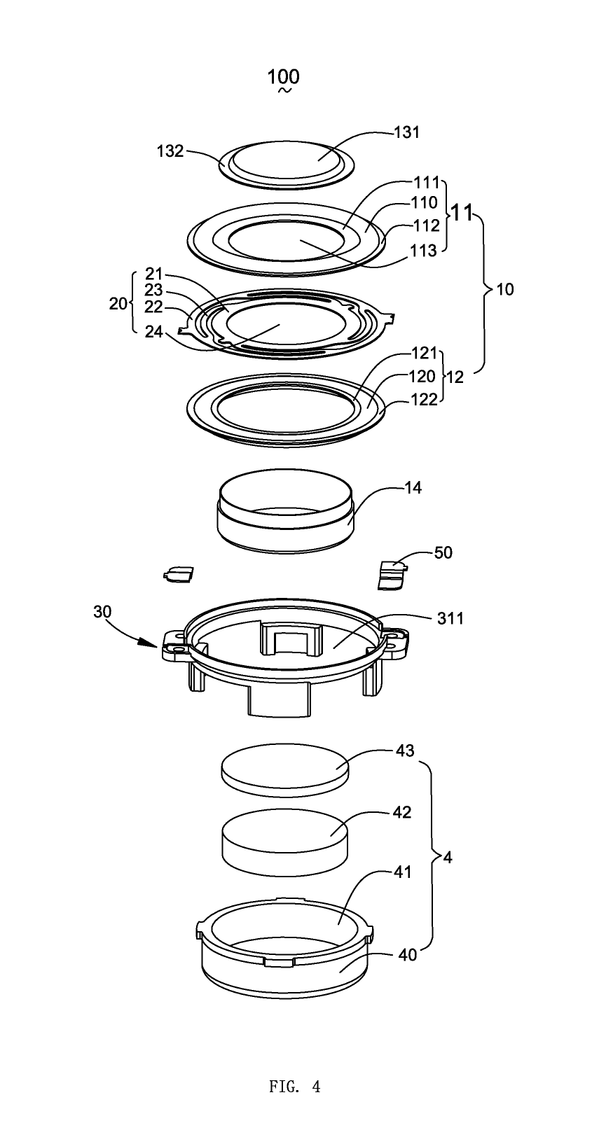

Referring to FIGS. 1 through 4, a micro-electroacoustic device 100, in the exemplary embodiment of the present invention, comprises a holder 30 forming a hollow space 311, a magnetic system 4 received in the hollow space 311 and having a magnetic gap 44, a suspension 20 assembled with the holder 30, a diaphragm 10 connected with the suspension 20, a coil 14 having an end suspended in the magnetic gap 44 and an another end directly or indirectly connected with the diaphragm 10 for driving the diaphragm 10 and the suspension 20, and a pair of terminals 50 assembled with the holder 30 for electrically connecting with the suspension 20. When electrified, the coil 14 is forced to move and drive the diaphragm 10 to move upwardly and downwardly along a vibrating direction for producing sound waves.

The magnetic circuit unit 4 comprises a base board 41, a first magnetic conduction member 42 disposed on a center portion of the base board 41, a second magnetic conduction member 40 disposed on a periphery portion of the base board 41 for forming the magnetic gap 44 together with the first magnetic conduction member 42. The base board 41 is made of magnetic conduction materials for effectively conducting magnetic fluxes. At least one of the first and second magnetic conduction members 42, 40 is a permanent magnet. In this embodiment, the first magnetic conduction member 42 is a permanent magnet and the second magnetic conduction 40 is integral with the base board 41 for conducting the magnetic fluxes generated from the first magnetic conduction member 42.

The suspension 20 is a planar sheet and comprises an inner ring portion 21, a central opening 24 surrounded by the inner ring portion 21, an outer ring portion 22 surrounding the inner ring portion 21 and fixed on the holder 30, and a plurality of elastic arms 23 disposed between and connecting the inner ring portion 21 and the outer ring portion 22. The inner ring portion is coplanar with the outer ring portion for reducing the height of the micro-electroacoustic device. A surface of the suspension 20 facing the magnetic system is defined as an upper surface, and another surface of the suspension opposite to the upper surface is defined as a lower surface.

The diaphragm 10 comprises an upper edge portion 11 attached on the upper surface of the suspension 20, a lower edge portion 12 attached on the lower surface of the suspension 20, and a dome part 13 attached on the suspension 20. The upper edge portion 11 comprises a first inner part 111 attached on the upper surface of the inner ring portion 21 of the suspension 20, a through hole 113 surrounded by the first inner part 111, a protruding part 110 extending from the first inner part 111 and protruding far away from the magnetic system 4, and a first outer part 112 extending from the protruding part 110 and being attached on the upper surface of the outer ring portion 22. The lower edge portion 12 comprises a second inner part 121 attached on the lower surface of the inner ring portion 21 of the suspension 20, a recessed part 120 recessed toward the magnetic system 4, and a second outer part 122 extending from the recessed part 120 and being attached on the lower surface of the outer ring portion 22. A protruding direction of the protruding part is opposite to a recessed direction of the recessed part. The protruding part 110 and the recessed part 120 are optionally symmetrical with the suspension for providing a restoring force evenly.

The dome part 13 has a main curved portion 131 protruding forward along the vibrating direction to form an annular bulge and a connecting portion 132 extending from the main curved portion 131. In this embodiment, the connecting portion 131 of the dome part 13 is attached on the lower surface of the inner ring portion 21 of the suspension 20 for supporting the suspension 20 together with the lower edge portion 12, and the main curved portion 131 passes through the central opening 24 and the through hole respectively for increasing the frequency band rang. The voice coil 14 is directly connected with the connecting portion 132 of the dome part 13 for driving the diaphragm 10 rapidly.

In an alternative embodiment, the connecting portion of the dome part is sandwiched between the suspension and the first inner part of the upper edge portion, and the main curved portion is exposed from the through hole of the upper edge portion. The voice coil is directly connected with the suspension or the second inner part of the lower edge part. In another alternative embodiment, the connecting portion of the dome part is directly attached on the upper edge portion and far away from the suspension.

When the diaphragm vibrates along the vibrating direction, the upper edge portion cooperates with the lower edge portion for supporting the voice coil evenly. Thus, the vibrating of the diaphragm is stable and balanced. By means of the micro-electroacoustic device, reliability of products can be improved.

It will be understood that the above particular embodiment is shown and described by way of illustration only. The principles and the features of the present disclosure may be employed in various and numerous embodiments thereof without departing from the scope of the disclosure as claimed. The above-described embodiment illustrates the scope of the disclosure but do not restrict the scope of the disclosure.

What is claimed is:

1. A micro-electroacoustic device comprising:
a holder forming a hollow space;
a magnetic system received in the hollow space and comprising a magnetic gap;
a vibrating system comprising a diaphragm and a coil driving the diaphragm for vibrating approaching and away from the magnetic system along a vibrating direction;
the diaphragm assembled with the holder and comprising an upper edge portion and a lower edge portion connected with the upper edge portion, the upper edge portion having a protruding part protruding away from the magnetic system, the lower edge portion having a recessed part recessed towards the magnetic system.

2. The micro-electroacoustic device as claimed in claim 1, wherein the protruding part and the recessed part are symmetrical with the suspension.

3. The micro-electroacoustic device as claimed in claim 1 further comprising a suspension located between the upper and lower edge parts.

4. The micro-electroacoustic device as claimed in claim 3 further comprising a dome part attached on the upper edge part.

5. The micro-electroacoustic device as claimed in claim 3, wherein the upper edge part further has a first inner part extending from the protruding part, and a through hole surrounding by the first inner part; the micro-electroacoustic device further has a dome part has a main curve portion passed through the through hole and a connecting portion extending from the main curved portion and far away from the main curved portion and located between the suspension and the first inner part.

6. The micro-electroacoustic device as claimed in claim 3, wherein the upper edge part further has a first inner part extending from the protruding part, and a through hole surrounding by the first inner part; the micro-electroacoustic device further has a dome part having a main curve portion and a connecting portion extending from the main curved portion and far away from the main curved portion; the suspension has a central opening; the connecting portion of the dome part is attached on the first inner part of the suspension and the main curved portion is passed through the central opening and the through hole respectively for increasing the frequency band rang and supporting the suspension together with the lower edge portion.

7. The micro-electroacoustic device as claimed in claim 6, wherein one end of the voice coil is connected with the connecting portion.

8. The micro-electroacoustic device as claimed in claim 4, wherein one end of the voice coil is connected with the lower edge portion.

9. A micro-electroacoustic device, comprising:
a holder forming a hollow space;
a magnetic system accommodated in the hollow pace, the magnetic system comprising a magnetic gap;
a diaphragm assembled with the holder, the diaphragm including a dome located at a center of the diaphragm, and an edge part surrounding the dome part; and
a voice coil for driving the diaphragm including an end disposed in the magnetic gap;
wherein the edge part comprises an inner part surrounding the dome part, an outer part suspending the diaphragm, and a protruding part located between the inner part and the outer part, the protruding part including a first protrusion protruding far away from the magnetic system, and a second protrusion protruding toward the magnetic system.

10. The micro-electroacoustic device as described in claim 9, wherein the edge part includes an upper edge part and a lower edge part, the upper edge part forming the first protrusion, and the lower edge part forming the second protrusion.

11. The micro-electroacoustic device as described in claim 10, wherein the dome includes a connecting part located between the upper edge part and the lower edge part.

12. The micro-electroacoustic device as described in claim 10, wherein the dome includes a connecting part located above the upper edge part.

13. The micro-electroacoustic device as described in claim 10, wherein the dome includes a connecting part located below the lower edge part.

14. The micro-electroacoustic device as described in claim 9 further comprising a suspension electrically connecting with the voice coil, the suspension including an inner ring part surrounding the dome, an outer ring part coupled to the outer part of the edge part, and a plurality of elastic arms located between the inner ring part and the outer ring part.

15. The micro-electroacoustic device as described in claim 14, wherein the suspension locates between the first protrusion and the second protrusion.
